(19) United States
(12) Patent Application Publication
(10) Pub. No.: US 2025/0342559 A1
(43) Pub. Date: Nov. 6, 2025

(54) MOBILE INFORMATION TERMINAL AND OBJECT DISPLAY METHOD

(71) Applicant: MAXELL, LTD., Kyoto (JP)

(72) Inventors: Yasunobu HASHIMOTO, Kyoto (JP); Kazuhiko YOSHIZAWA, Kyoto (JP); Osamu KAWAMAE, Kyoto (JP); Mayumi NAKADE, Kyoto (JP); Nobuo MASUOKA, Kyoto (JP); Hitoshi AKIYAMA, Kyoto (JP); Hideyuki NAGATA, Kyoto (JP)

(21) Appl. No.: 18/690,894

(22) PCT Filed: Sep. 13, 2021
(86) PCT No.: PCT/JP2021/033548

§ 371 Date: Dec. 5, 2024

(51) Int. Cl. G06T 3/40; G06F 3/01; G06T 11/00; G06V 40/20

(52) U.S. Cl. CPC G06T 3/40; G06F 3/017; G06T 11/00; G06V 40/28; G06T 2200/24; G06T 2210/62

(57) ABSTRACT

A mobile information terminal comprises a display and a processor configured to carry out display control of the display, and the processor calculates coordinates on which the display object is to be displayed, using, as a coordinate system for displaying the display object, a local coordinate system that is fixed to the mobile information terminal and at least one non-local coordinate system that is not fixed to the mobile information terminal, and upon displaying an enlarged area display object, which is an object relating to the display object that is being displayed on the local coordinate system and requires, for displaying thereof, an enlarged area extending beyond a display area within the display, places the enlarged area display object on the non-local coordinate system.

### TECHNICAL FIELD

The present invention relates to a mobile information terminal and an object display method, in particular, provides a mobile information terminal which is suitable for displaying a virtual object and has improved usability and an object display method.

### BACKGROUND ART

Conventionally, there is a technique of displaying a virtual object on a head-mounted display (HMD). As coordinate systems used in such a conventional technique of displaying a virtual object, a world coordinate system and a local coordinate system are known.

The world coordinate system is the coordinate system of the real world, and a virtual object placed in the world coordinate system cannot be seen from a user when he or she moves away from the place. On the other hand, the world coordinate system is as large as the real world, which allows a large number of virtual objects to be placed thereon.

On the other hand, the local coordinate system is the coordinate system fixed to an HMD, and the positional relationship with a display mounted on the HMD is also fixed. On the display, a virtual object placed in the direction in which a display surface of the display is present as viewed from the user is shown. Placing the virtual object on the local coordinate system within a direction range in which the display surface of the display is present enables the virtual object to be constantly shown and thus operated, since the display has been fixed to the local coordinate system even when the user wearing the HMD moves. On the other hand, the local coordinate system only allows the virtual objects placed in the direction range described above to be displayed, and thus the number of virtual objects to be placed thereon is limited.

As described above, the conventional technique with only two coordinate systems on which virtual objects are to be placed, which are the world coordinate system and the local coordinate system, has a problem that a large number of virtual objects to which a user wants to frequently refer cannot be placed. Furthermore, there is a further problem of reduction in the visibility of the outside world if forcibly placing the virtual object in a direction in which the display surface of the display is present.

In order to solve these problems, Patent Literature 1 discloses that “a virtual object display device is provided with a display and a display control device which performs display control of the display, wherein the display control device comprises: a coordinate system calculation unit which detects movement and rotation within the real world of the virtual object display device, and defines a placement position for an inertial coordinate system virtual object using an inertial coordinate system wherein the coordinate origin follows the movement of a virtual object device, and the effective field of view of the display rotates within the coordinate system as the virtual object display device rotates; and a display control unit which displays the inertial coordinate system virtual object in the effective field of view of the display if the effective field of view contains the inertial coordinate system virtual object” (excerpted from Abstract).

### CITATION LIST

### Patent Literature

Patent Literature 1: WO2020/157955

### SUMMARY OF INVENTION

### Technical Problem

In Patent Literature 1, as a coordinate system on which a virtual object is to be placed, the inertial coordinate system is provided in addition to the local coordinate system and the world coordinate system, so as to increase the variations of a object display method and thus improve the usability.

However, for a virtual object placed on the local coordinate system, a placement coordinate system in displaying a related virtual object requiring a large display area is not considered in Patent Literature 1. More specifically, there is a problem that, when the size of a virtual object placed on the local coordinate system is changed, the virtual object extending beyond the display cannot be viewed unless the display area of the display is changed by a further action, for example, scrolling the display.

The present invention has been made in view of the circumstances described above, and an object of the present invention is to further improve the usability in displaying a display object using a local coordinate system and a coordinate system different from the local coordinate system.

### Solution to Problem

In order to solve the problems described above, the present invention includes the features described in the scope of claims. One of the aspects thereof is a mobile information terminal for displaying a display object, comprising: a display; and a processor configured to carry out display control of the display, the processor being configured to: calculate coordinates on which the display object is to be displayed, using, as a coordinate system for displaying the display object, a local coordinate system that is fixed to the mobile information terminal and a non-local coordinate system that is not fixed to the mobile information terminal; and upon displaying an enlarged area display object, which is an object relating to the display object that is being displayed on the local coordinate system and requires, for displaying thereof, an enlarged area extending beyond a display area within the display, place the enlarged area display object on the non-local coordinate system.

### Advantageous Effects of Invention

According to the present invention, it is possible to further improve the usability in displaying a display object using a local coordinate system and a coordinate system different from the local coordinate system. The problems, configurations, and advantageous effects other than those described above will be clarified by explanation of the embodiments below.

### BRIEF DESCRIPTION OF DRAWINGS

FIG. 1 illustrates an example of a structure of the appearance of an HMD.

FIG. 2 illustrates an example of a functional block configuration of an HMD.

FIG. 3 illustrates a flowchart of a flow of the processing of the simple enlargement display.

FIG. 4 is a diagram for explaining transition of display modes in the simple enlargement display.

FIG. 5 illustrates a flowchart of a flow of the processing of the forcibly enlarged area display.

FIG. 6 illustrates a modified example of the simple enlargement display.

FIG. 7 illustrates an example of the large related display.

FIG. 8 illustrates an example of the large related display.

FIG. 9 illustrates an example of the large related display.

FIG. 10A illustrates a flowchart of a flow of the processing of FIG. 9.

FIG. 10B illustrates a flowchart of a flow of the processing of FIG. 9.

FIG. 11 illustrates an example of the avoidance display.

FIG. 12 illustrates a flowchart of a flow of the processing of FIG. 11.

FIG. 13 illustrates a further example of the avoidance display.

FIG. 14 illustrates a flowchart of a flow of the processing of FIG. 13.

FIG. 15 illustrates an example of the change of transparency for display.

FIG. 16 is a diagram for explaining a chest coordinate system (X_{B}, Y_{B}, Z_{B}).

FIG. 17 is a diagram for explaining an inertial coordinate system (X_{I}, Y_{I}, Z_{I}).

FIG. 18 is a diagram for explaining a direction-fixed nonlocal coordinate system (X_{V}, Y_{V}, Z_{V}).

FIG. 19 is a diagram for explaining a plane-fixed nonlocal coordinate system (X_{P}, Y_{P}).

FIG. 20 is a diagram for explaining a plane-fixed nonlocal coordinate system (X_{P}, Y_{P}).

FIG. 21 is a diagram of explaining a user interface according to the second embodiment.

FIG. 22 is a diagram of explaining a user interface according to the third embodiment.

### DESCRIPTION OF EMBODIMENTS

Hereinafter, exemplified embodiments according to the present invention will be described with reference to the drawings. Throughout all the drawings, the same components and steps are provided with the same reference signs, and repetitive explanation thereof will be omitted.

### <Hardware Configuration>

In the following embodiments, an HMD (head-mounted display) is exemplified and described as a mobile information terminal.

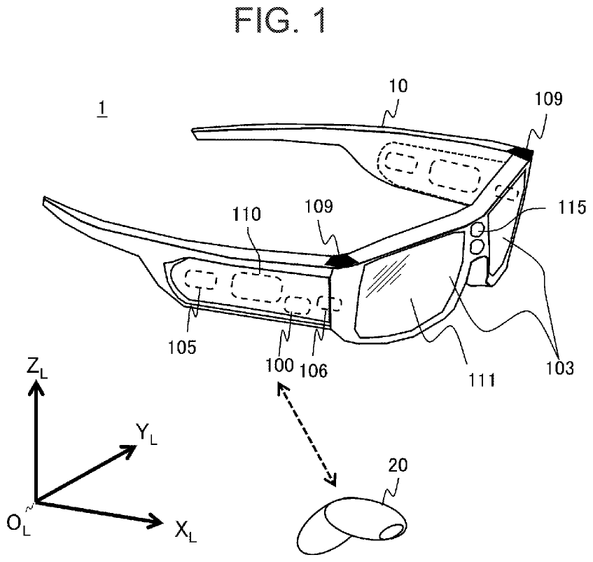

FIG. 1 illustrates an example of a structure of the appearance of an HMD 1.

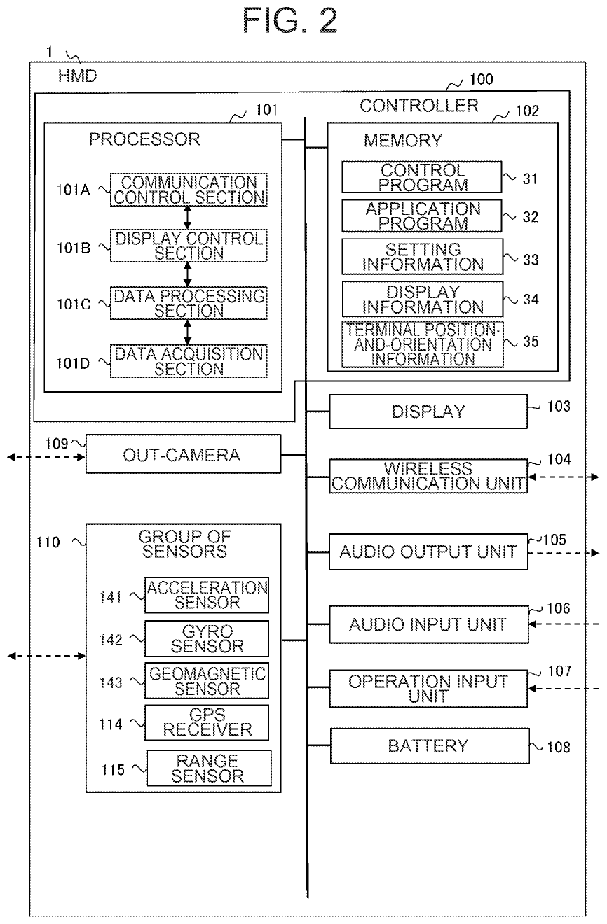

FIG. 1 illustrates the HMD 1 configured with a housing 10 having the shape of eyeglasses, in which a display 103 including a display area 111 is provided. For example, the display 103 is a see-through display, which allows a real image of the outside world to be viewed through the display area 111, and an image is superimposed and displayed on the real image. The housing 10 includes a controller 100, an out-camera 109, a range sensor 115, and other sensors (referred to as a group of sensors 110 in FIG. 1) excluding the range sensor 115. FIG. 1 illustrates the range sensor 115 separately from the group of sensors 110, on the other hand, the range sensor 115 is a kind of sensors as well, and thus it is illustrated in FIG. 2, which will be described later, as being included in the group of sensors 110.

The out-camera 109 includes, for example, two cameras arranged on both the left and right sides of the housing 10, and captures an image of a range including the front of the HMD 1 to acquire the image. The range including the front of the HMD 1 includes an area where the user wearing the HMD 1 can view.

The range sensor 115 is the sensor for measuring a distance between the HMD 1 and an object in the outside world. The range sensor 115 may be a TOF (Time Of Flight) sensor, or may be a stereo camera or a sensor of other types.

The group of sensors 110 includes a plurality of sensors for detecting the position and orientation of the HMD 1. On the left and right of the housing 10, an audio input unit 106 including a microphone, an audio output unit 105 including a speaker and an earphone terminal, and the like are provided.

The HMD 1 may be provided with an operation unit 20 such as a remote controller. In this case, for example, the HMD 1 carries out near-field wireless communication with the operation unit 20. The user operates the operation unit 20 with his or her hand to enter an instruction for the functions of the HMD 1, move a cursor in the display area 111, and the like.

The HMD 1 may be linked with an external device (for example, a smartphone, a PC, or the like) by communication. For example, the HMD 1 may receive image data on an AR (Augmented Reality) object from an application software provided in the external device.

The HMD 1 may display a display object in the display area 111. For example, the HMD 1 generates a display object for guiding the user to displays it in the display area 111. When viewed from a user, the display object being displayed in the display area 111 is an AR object placed in an augmented reality space which is added to the real world to be viewed through the display area 111.

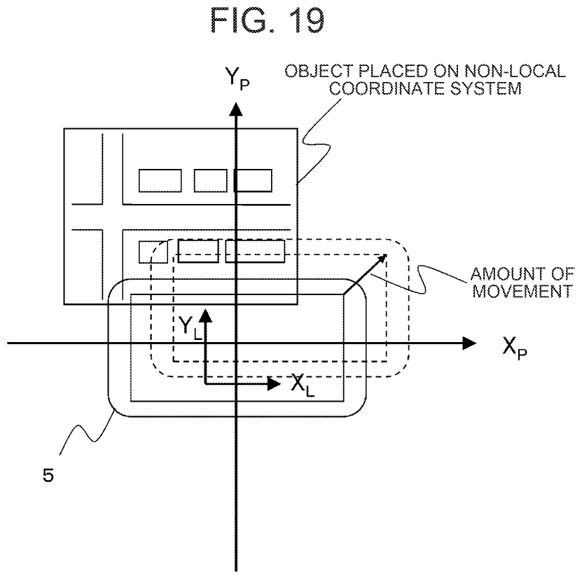

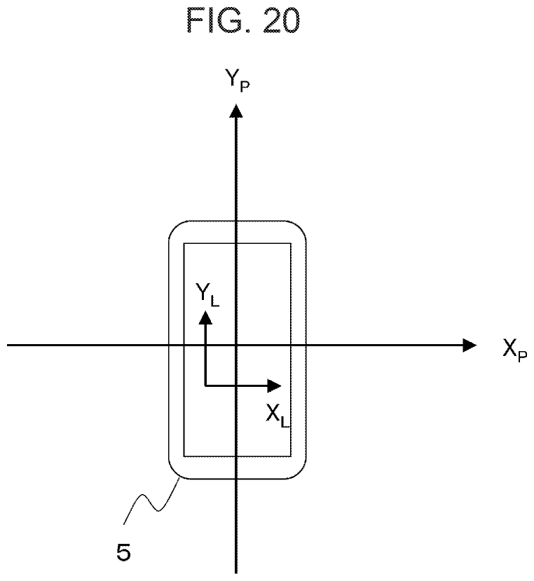

FIG. 2 illustrates an example of a functional block configuration of the HMD 1 of FIG. 1. In the present embodiment, the HMD 1 is exemplified as a mobile information terminal, on the other hand, a mobile information terminal other than an HMD, for example, a smartphone 5 (see FIG. 19 and FIG. 20) or a tablet terminal has the same configuration.

The HMD 1 includes a processor 101, a memory 102, the display 103, a wireless communication unit 104, the audio output unit 105 including a speaker and the like, the audio input unit 106 including a microphone, an operation input unit 107, a battery 108, the out-camera 109, the group of sensors 110, and the like. These components are connected to each other through a bus or the like.

The processor 101 is configured with a CPU, a GPU, and the like, and configures the controller 100 of the HMD 1. The processor 101 executes the processing in accordance with a control program 31 and an application program 32 stored in the memory 102, whereby the functions of an OS, middleware, and applications and other functions are implemented.

The memory 102 is configured with a ROM, a RAM, or the like, and stores various types of data and information to be handled by the processor 101 and the like. The memory 102 also retains, as temporary information, an image acquired by the out-camera 109, detection information, and the like.

The out-camera 109 converts a light incident from a lens into an electric signal by means of an image sensor to acquire an image.

In the case of employing a TOF (Time Of Flight) sensor as the range sensor 115, it calculates a distance to an object based on the time until a light emitted to the outside strikes the object and returns.

The group of sensors 110 includes, for example, an acceleration sensor 111, a gyro sensor (angular velocity sensor) 112, a geomagnetic sensor 113, a GPS receiver 114, and the range sensor 115. Using the detected information, the group of sensors 110 detects the position, orientation, motion, and the like of the HMD 1. The sensors to be provided in the HMD 1 is not limited thereto, but an illuminance sensor, a proximity sensor, an atmospheric pressure sensor, and the like may be included.

The display 103 includes a display drive circuitry and the display area 111, and displays a display object in the display area 111 based on image data in display information 34. The display 103 is not limited to a transparent display, and may be a non-transparent display or the like.

The wireless communication unit 104 includes a communication processing circuitry, an antenna, and the like which are adaptable to various predetermined communication interfaces. Examples of the communication interfaces are a mobile network, Wi-Fi (registered mark), Bluetooth (registered mark), infrared rays, and the like. The wireless communication unit 104 carries out the wireless communication processing or the like with other HMDs 1 or an access point. The wireless communication unit 104 also carries out the near-field communication processing with the operation unit 20.

The audio input unit 106 converts a sound input from the microphone into audio data. The audio input unit 106 may include an audio recognition function.

The audio output unit 105 outputs a sound from a speaker or the like based on the audio data. The audio output unit 105 may include an audio composition function.

The operation input unit 107 is the unit for accepting an operation input to the HMD 1, for example, an operation of turning on or off, control of a volume, and the like, and is configured with a hardware button, a touch sensor, or the like.

The battery 108 supplies an electric power to each part.

As an exemplary functional block configuration to be realized by the processing, the processor 101 includes a communication control section 101A, a display control section 101B, a data processing section 101C, and a data acquisition section 101D.

In the memory 102, the control program 31, the application program 32, setting information 33, the display information 34, terminal position-and-orientation information 35, and the like are stored.

The control program 31 is the program for realizing control of the whole of the HMD 1 including the display control.

The application program 32 includes various programs used by the user.

The setting information 33 includes system setting information and user setting information relating to each of the functions.

The display information 34 includes image data and position coordinate information for displaying a display object in the display area 111.

The terminal position-and-orientation information 35 is the information relating a movement and change in the orientation of the HMD 1, which is used in calculation of the position and orientation of the mobile information terminal on the non-local coordinate system.

The communication control section 101A controls the communication processing using the wireless communication unit 104 in the communication with other HMDs 1 or the like.

The display control section 101B controls display of a display object in the display area 111 of the display 103 using the display information 34.

The data processing section 101C reads and writes the terminal position-and-orientation information 35, and calculates the position and orientation of the mobile information terminal on the non-local coordinate system.

The data acquisition section 101D acquires detected data from the out-camera 109 and various sensors such as the group of sensors 110, and generates the terminal position-and-orientation information 35.

### First Embodiment

The first embodiment is the embodiment for the case where the mobile information terminal 1 receives, from a user, a display change instruction for a display object placed on a local coordinate system and a display object to be newly displayed requires an area larger than a display area of the local coordinate system, and in the present embodiment, the display object to be newly displayed is placed on a non-local coordinate system and displayed.

Before describing the first embodiment, the terms used in the present embodiment will be explained.

The “local coordinate system” is the coordinate system that is fixed to the display area 111 of the display 103 of the HMD 1. The local coordinate system is the coordinate system which allows a user wearing the HMD 1 to see an object thereon in front of the eyes, no matter he or she turns the face as long as the display area 111 is positioned in front of the eyes.

The “non-local coordinate system” is the coordinate system that is not fixed to the display area 111 of the display 103. For example, the non-local coordinate system includes a world coordinate system (X_{W}, Y_{W}, Z_{W}) that is fixed to the real space. The display area of the non-local coordinate system can be changed by changing the direction and position of the HMD 1. In other words, the non-local coordinate system is the coordinate system in which, when a user of the HMD 1 turning his or her face around, what he or she can view changes. The non-local coordinate system includes, for example, in addition to the world coordinate system, a coordinate system that is fixed to the front of the body from the neck of a user down, and an inertial coordinate system which defines a direction in which the face is directed on average as the front. These coordinate systems will be described later.

The “enlarged area display” is applied when an area larger than the display area 111 of the display 103 is required for displaying a display object. In other words, in the “enlarged area display”, an “enlarged area” is required but the display object would not be always “enlarged”. In the following, placing a display object in the same size, without “enlarging” it, beyond the display area 111 of the display 103 may be referred to as “avoidance display”.

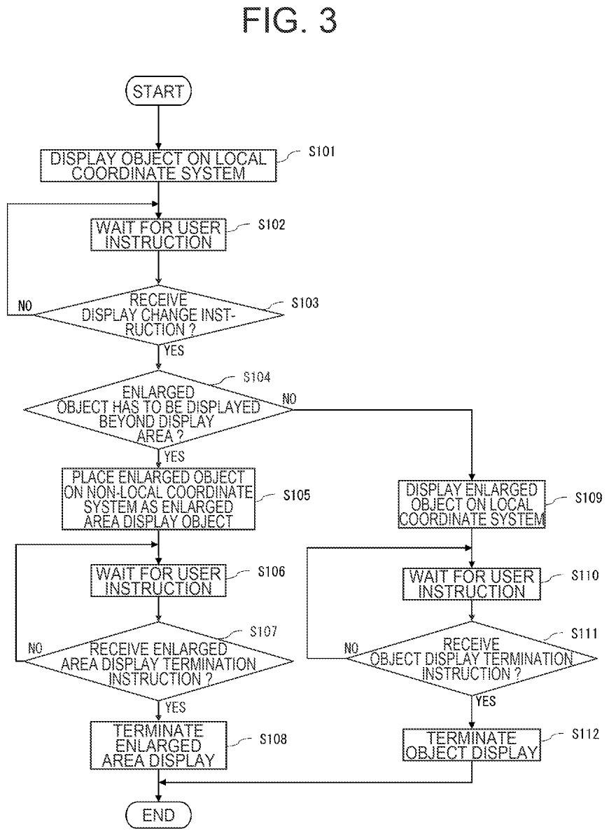

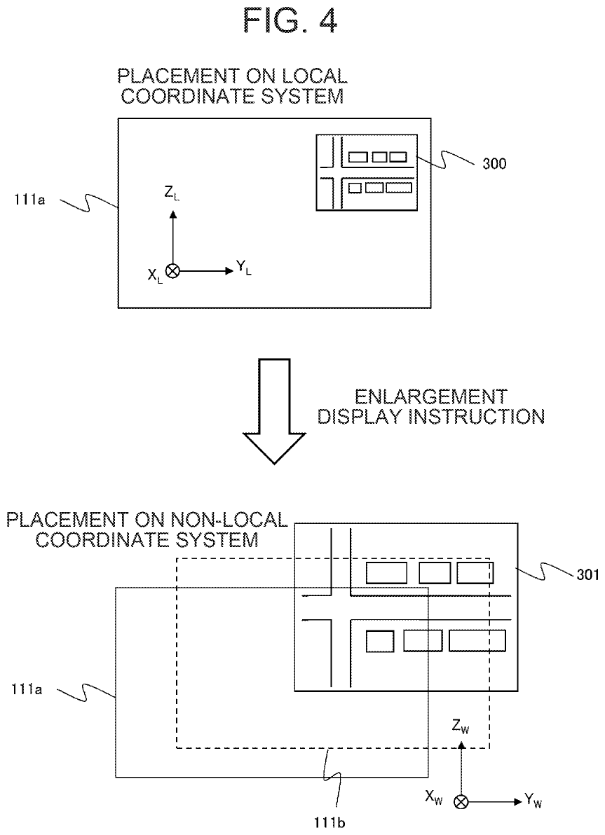

The first embodiment will be described with reference to FIG. 3 and FIG. 4. FIG. 3 illustrates a flowchart of a flow of simple enlargement display processing. FIG. 4 illustrates a transition of display modes of the simple enlargement display. In the following, an example where a display change instruction is a “simple enlargement display instruction” will be described in the order of steps of FIG. 3.

### (Simple Enlargement Display)

The simple enlargement display is the display mode for enlarging a display object being displayed on a local coordinate system and displaying it as an enlarged display object of the same content on the local coordinate system or a non-local coordinate system.

The processor 101 of the HMD 1 initially displays a display object 300 in the display area 111a as illustrated in the upper part of FIG. 4 (step S101). The coordinate system indicating a display position of the display object 300 within the display area 111a of the HMD 1 is a local coordinate system that is fixed to the HMD 1. The local coordinate system is a three-axis rectangular coordinate system, where the left and right direction of the display area 111a is the Y_{L} axis, the height direction of the display area 111a is the Z_{L} axis, and the depth direction perpendicular to the display area 111a is the X_{L} axis. A display position in the display area 111a is, if being limited to a certain plane, can be expressed by two-dimensional coordinates (Y_{L}, Z_{L}). A display object may be three-dimensionally placed with respect to the local coordinate system. In this case, the display position thereof is expressed by three-dimensional coordinates (X_{L}, Y_{L}, Z_{L}), and the display area which can be viewed by a user is a pyramidal area having the viewpoint of the user as a vertex.

The processor 101 waits for a user instruction with the display object 300 being placed on the local coordinate system (X_{L}, Y_{L}, Z_{L}) and displayed in the display area 111a (step S102). The processor 101 keeps waiting (step S102) until it receives the display change instruction from the user (step S103: NO).

When, the user provides an instruction “simple enlargement display instruction” for displaying an enlarged display object relating to the display object 300 as a display change instruction and the processor 101 accepts an input of the simple enlargement display instruction (step S103: Yes), the processor 101 calculates the size of an enlarged object 301 obtained by enlarging the display object 300 to determine whether it has to be displayed beyond the display area 111a (step S104).

Upon determining that the enlarged object 301 cannot be fully displayed within the display area 111a and thus has to be displayed beyond the display area 111a (step S104: Yes), the processor 101 places the enlarged object 301 on a non-local coordinate system (for example, world coordinate system) as an enlarged area display object (step S105). In the example of FIG. 4, the enlarged object 301 obtained by simple enlargement of the display object 300 cannot be displayed unless it extends beyond the display area 111a. Accordingly, the processor 101 places the enlarged object 301 on the non-local coordinate system as the enlarged area display object. “Placing the enlarged object 301 on the non-local coordinate system” means, in particular, that the processor 101 calculates the coordinates of the enlarged object 301 on the non-local coordinate system and stores the coordinates in the display information 34. Using the terminal position-and-orientation information 35 and the display information 34 causes the enlarged object 301 to be displayed on the display 103 of the HMD 1 upon being included in the pyramidal directional position of the display area 111 of the HMD 1.

As illustrated in the lower part of FIG. 4, a portion of the enlarged object 301 placed on the non-local coordinate system, which extends beyond the displayed area 111a, cannot be viewed as it is. In this state, moving the HMD 1 in the upper right direction in FIG. 4 causes the position of the enlarged object 301 within the non-local coordinate system to be moved from the display area 111a to the display area 111b. In the display area 111b, a larger portion of the enlarged object 301 is displayed.

The processor 101 waits for a user instruction with the enlarged object 301 (enlarged area display object) being placed on the non-local coordinate system (X_{L}, Y_{L}, Z_{L}) (step S106).

Upon accepting an input of an enlarged area display termination instruction (step S107: YES), the processor 101 terminates the enlarged area display (step S108).

“Terminating the enlarged area display” refers to restoring the display object 300 by reducing the enlarged object 301 to the size of the display object 300, and placing it on the local coordinate system again. The processor 101 keeps waiting (step S106) in absence of the user instruction (step S107: NO).

On the other hand, upon determining that the enlarged object can be displayed within the display area 111a (step S104: NO), the processor 101 displays the enlarged object with being placed on the local coordinate system as it is (step S109).

The processor 101 waits for a user instruction with the enlarged object being placed on the local coordinate system (X_{L}, Y_{L}, Z_{L}) (step S110).

Upon accepting an input of a display termination instruction for the display object 300 (step S111: YES), the processor 101 terminates the display thereof (step S112). In absence of the display termination instruction (step S111: NO), the processor 101 keeps waiting for the instruction from the user (step S110).

### (Forcibly Enlarged Area Display)

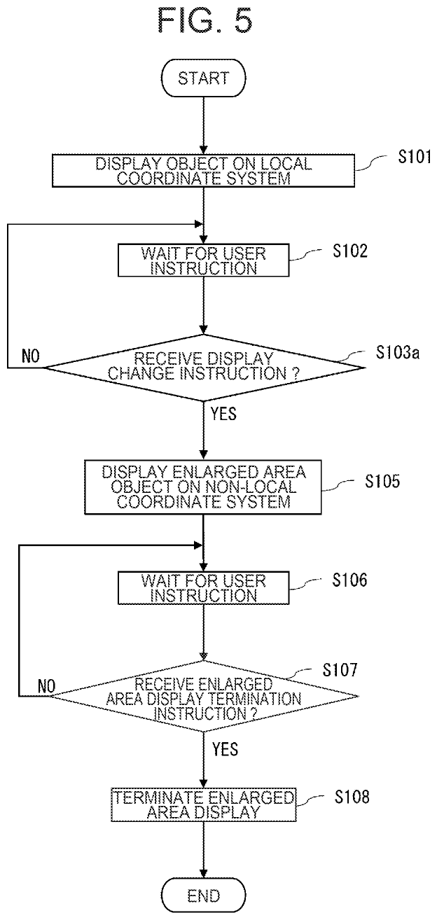

Forcibly enlarged area display, which is a modified example of the simple enlargement display, will be described. FIG. 5 illustrates a flowchart of a flow of forcibly enlarged area display processing. Regardless of the size of a displayed object after enlargement, forcibly enlarged area display is applied to the enlarged display object so that the enlarged display object is placed on the non-local coordinate system. This is suitable for the case where not only the display object is enlarged, but also a user wants to look at the display object carefully at the direction of the front of the line of sight, that is, the direction of the front of his or her face.

The flowchart of the forcibly enlarged area display processing illustrated in FIG. 5 is basically the same as the flowchart illustrated in FIG. 3, but differs therefrom in including no branch of the case of not applying the enlarged area display. Furthermore, the confirmation of whether the user instruction is accepted is changed to the confirmation of whether the forcibly enlarged area instruction is accepted (step S103a).

### (Further Example of Simple Enlargement Display)

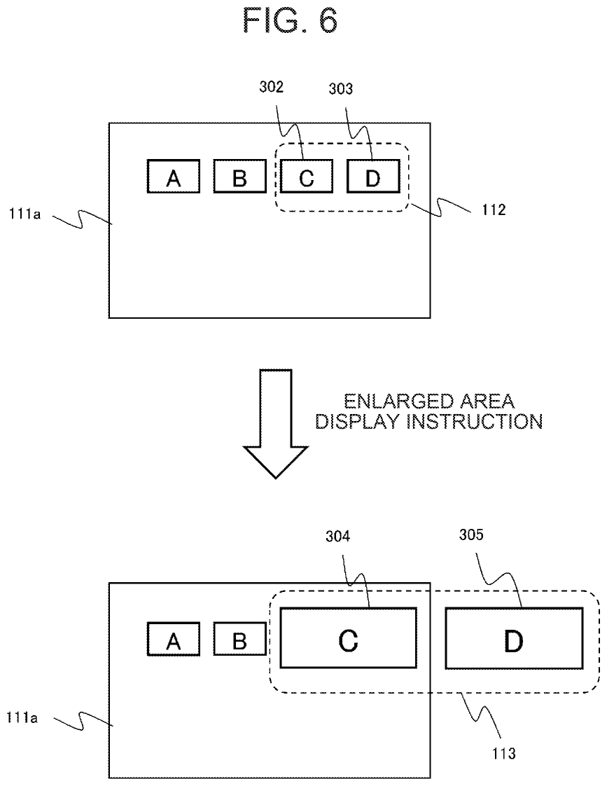

FIG. 6 illustrates a modified example of the simple enlargement display.

As a modified example of the simple enlargement, as illustrated in the upper part of FIG. 6, a partial area 112 that has been specified within the display area 111a may be a target of the enlargement display.

In the example of FIG. 6, the simple enlargement of the specified partial area 112 causes the simple enlargement of a plurality of display objects 302, 303 within the partial area 112a as well. The area in the image captured by the out-camera 109 may be cut out so as to enlarge a partial image portion as cut out. Enlarged objects 304, 305 obtained by enlarging the display objects 302, 303 that are the enlargement targets are both placed on a non-local coordinate system as the enlarged area display objects.

In the example of FIG. 6, upon accepting the specification of the partial area 112 and the “enlarged area display instruction” therefor as the “display change instruction” from the user (step S103), the processor 101 generates an enlarged object 113 obtained by the simple enlargement of the whole of the partial area 112. In the enlarged object 113, the enlarged objects 304, 305 obtained by the simple enlargement of each of the display objects 302, 303 are included. The processor 101 places the enlarged object 113 on a non-local coordinate system (for example, world coordinate system) as the enlarged area display object to display it (step S105).

In addition to the simple enlargement display illustrated in FIG. 5 and FIG. 6, other types of enlarged area display will be described.

### (Large Related Display)

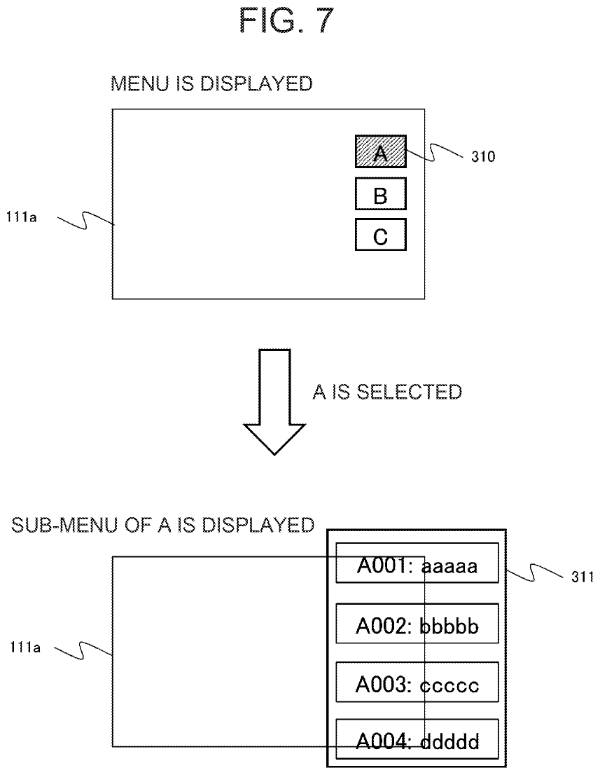

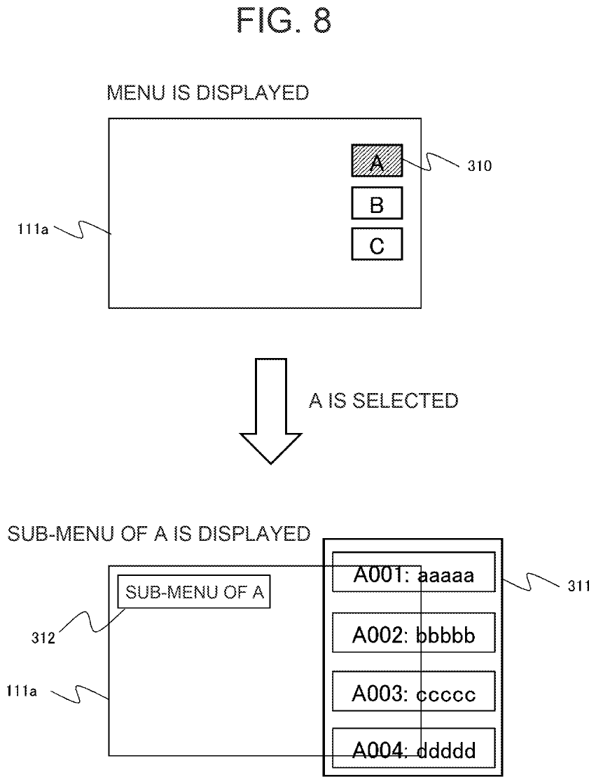

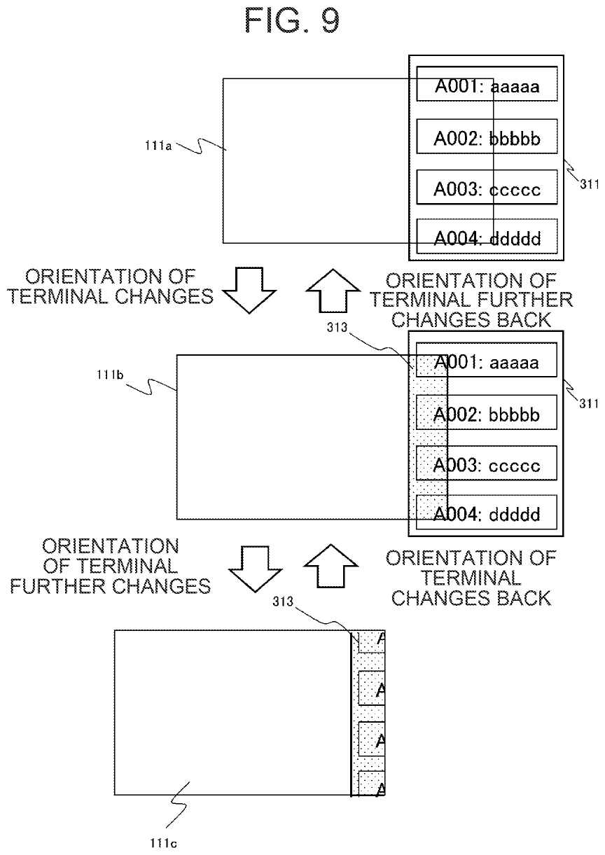

The “large related display” is applied when a display object is to be changed to another display object related thereto or a new display object related thereto is to be displayed. In the large related display, the enlarged area display is applied when the related display object requires a large display area that extends beyond a display area. The related display will be described with reference to FIG. 7 to FIG. 9. Each of FIG. 7, FIG. 8, and FIG. 9 illustrates an example of the related display in which menu display is used as an example.

In the example of FIG. 7, when a user provides a selection instruction to select one item of a menu object 310 placed on a local coordinate system, the processor 101 accepts the “selection instruction” as the “display change instruction” (step S103: YES). The processor 101 reads a sub-menu 311 that has been associated with the menu object 310 from the display information 34. When the sub-menu 311 cannot be fully displayed in the display area 111a and thus it is determined that the sub-menu 311 has to be displayed beyond the display area 111a (step S104: Yes), the processor 101 interprets the “display change instruction” as the “enlarged area display instruction”, and places the sub-menu 311 on a non-local coordinate system (for example, world coordinate system) to display it (step S105). In this case as well, the processor 101 may accept the “forcibly enlarged area display instruction” to forcibly place the sub-menu 311 on the non-local coordinate system regardless of the size of the sub-menu 311.

In the further example of FIG. 8, the sub-menu 311 is placed on a non-local coordinate system (for example, world coordinate system) and displayed (step S105), and moreover, a title object 312 indicating that the sub-menu 311 is being placed on the non-local coordinate system is placed on the local coordinate system. That is, in step S105, the processor 101 adds and executes the processing of placing the title object 312 on the local coordinate system.

Upon being placed on the non-local coordinate system, the sub-menu 311 may extend beyond the display area 111a depending on the orientation of the HMD 1 and becomes invisible. Accordingly, the title object 312 is placed on the local coordinate system to notify that the sub-menu 311 is being placed on the non-local coordinate system.

FIG. 9 illustrates an example for eliminating the inconvenience in which the sub-menu 311 placed on a non-local coordinate system extends beyond the display area 111a depending on the orientation of the HMD 1 and thus becomes invisible in the same manner as FIG. 8. In the display area 111a illustrated in the upper part of FIG. 9, approximately the left half of the sub-menu 311 is being displayed in the display area 111a. Here, directing the HMD 1 to the left causes, as shown by a display area 111b illustrated in the middle of FIG. 9, only the left end side to be displayed further to the left than the left half of the sub-menu 311. As illustrated in the upper part of FIG. 9 and the middle part of FIG. 9, when a partial area of the sub-menu 311 which remains in each of the display areas 111a, 111b is equal to or larger than a remaining area 313, the position of the sub-menu 311 does not change. Here, directing the HMD 1 further to the left causes the sub-menu 311 to be not displayed at all. Accordingly, as shown in a display area 111c illustrated in the lower part of FIG. 9, the remaining area 313 obtained by cutting out a portion of the sub-menu 311 is placed on a local coordinate system. This enables the notification that the sub-menu 311 is placed on the non-local coordinate system to be provided.

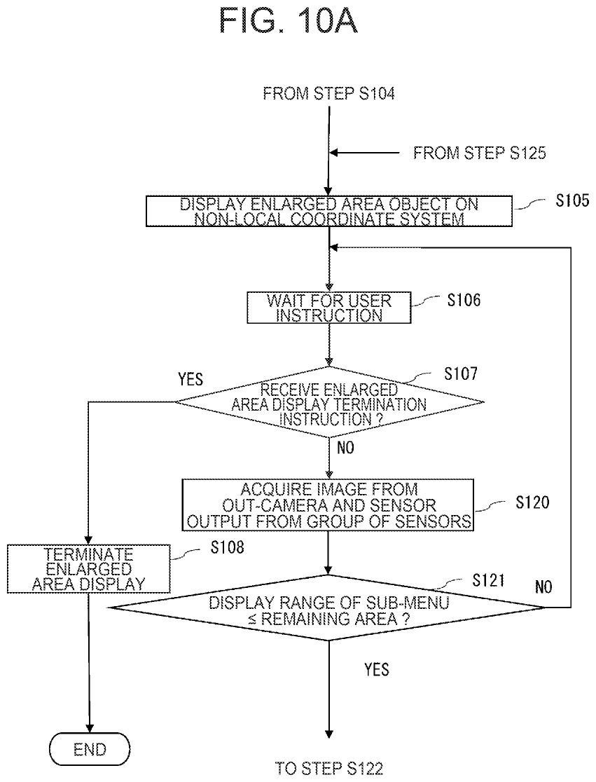

Each of FIG. 10A and FIG. 10B illustrates a flowchart of a flow of the processing of FIG. 9. In FIG. 9, the steps which are the same as those of FIG. 3 are provided with the common step numbers, if not, they are not mentioned.

The processor 101 places the sub-menu 311 on a non-local coordinate system (for example, world coordinate system) to display it (step S105), and waits for a user instruction (step S106). Upon accepting an input of the enlarged area display termination instruction (step S107: YES), the processor 101 terminates the enlarged area display (step S108). In absence of the user instruction (step S107: NO), the processor 101 acquires images from the out-camera 109 and sensor outputs from the group of sensors 110 (step S120) to calculate the position and orientation of the display area 111a on the non-local coordinate system. Then, the processor 101 compares the size of the display range in which the sub-menu 311 is being displayed in the display area 111a with the size of the remaining area 313. The size of the remaining area 313 to be left in the display area 111a is predetermined.

When the display range of the sub-menu 311 within the display area 111a is larger than the remaining area 313 (step S121: NO), the processor 101 returns to step S106 and waits for a user instruction.

When the display range of the sub-menu 311 within the display area 111a is equal to or smaller than the remaining area 313 (step S121: YES), the processor 101 cuts out the remaining area 313 from the sub-menu 311, and places the remaining area 313 as cut out on the local coordinate system to display it. In addition, the position of the sub-menu 311 on the non-local coordinate system at that time is stored (step S122). The display area 111b illustrated in FIG. 9 is in the state where the remaining area 313 is about to be cut out. The display area 111c is in the state where only the remaining area 313 is being displayed in accordance with the further change in the orientation of the HMD 1 from that in the state of the display area 111b.

The processor 101 waits for a user instruction (step S106), and acquires images from the out-camera 109 and sensor outputs from the group of sensors 110 until it accepts an enlarged area display termination instruction (step S107: NO) to monitor whether the position or orientation of the HMD 1 has restored to the position when the remaining area 313 starts being displayed (step S124).

When determining that the position or orientation of the HMD 1 has restored (step S124: YES), the processor 101 causes the mode of displaying the sub-menu 311 to be restored from the mode of displaying only the remaining area 313 (step S125). In the example of FIG. 9, the state of the display area 111a is restored. Then, the processor 101 returns to step S105.

When determining that the position or orientation of the HMD 1 has not been restored to the position when the remaining area 313 starts being displayed (step S124: NO), the processor 101 returns to step S106 while keeping the display state of the display area 111c.

Upon receiving an enlarged area display termination instruction (step S107: YES), the processor 101 terminates the enlarged area display, that is, terminates the display of the sub-menu 311 (step S108).

As described above, for an object which should not completely disappear from a display area, for example a menu, carrying out the enlarged area display using the remaining area 313 enables the display position of the object to be adjusted such that a minimum part thereof remains in a peripheral portion of the display area even if the position and orientation of the HMD 1 changes.

In the above, the example of the large related display has been described using the menu display as an example, however, the large related display is not limited to the menu display. For example, it may be applied to the case of displaying a new object in accordance with a hierarchical transition in an application. Alternatively, it may be applied to the case of displaying a new object in accordance with start-up of an application placed on the local coordinate system.

Furthermore, for each object to be newly displayed, a coordinate system for displaying it may be specified using a management table or the like. In this case, it may be configured that a coordinate system is specified depending on the size of a display object. Alternatively, it may be configured that a non-local coordinate system is specified regardless of the size of a display object, or a local coordinate system is specified for the case where a display object is small. Furthermore, the initial display position of a display object may be specified. For the case where a display coordinate system is specified as described above, the processing is carried out with the specification being interpreted as a display change instruction or enlarged area display instruction from a user. The content of the management table may be changed by a user.

The same processing may be carried out not only for the case of displaying a new display object in accordance with a display change instruction from a user, but also for the case of automatically displaying a display object by an application or the like. That is, the display object automatically displayed by the application or the like may be placed on the local coordinate system when it can be displayed in a display area of a local coordinate system, while it may be placed on the non-local coordinate system otherwise.

### (Display Position Limitation 1: Avoidance Display)

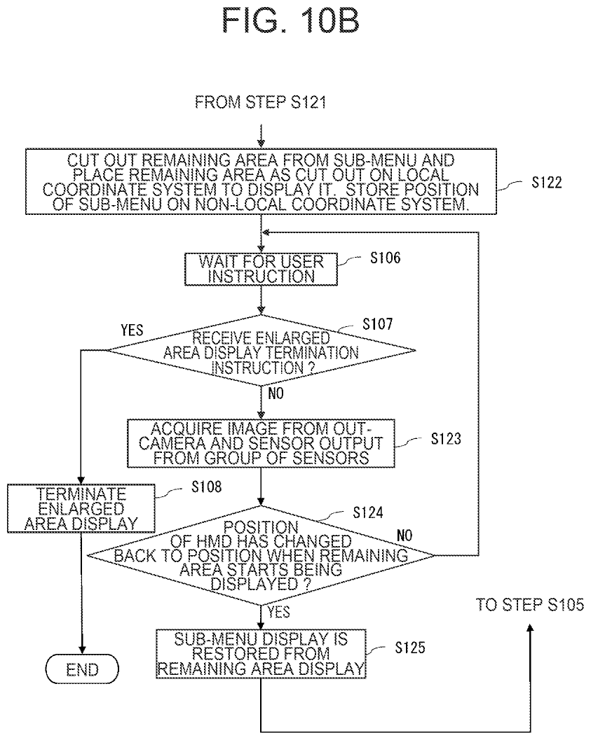

If switching to the enlarged area display causes obstruction of the visibility of other objects including a real object in the outside world, an “avoidance display” for moving a display object away to a display position that does not obstruct the visibility may be carried out. The “avoidance display” is the display mode for the case where a user of the HMD of a transparent type is viewing an object in the outside world and the visibility of the object is obstructed by a display object, and in this display mode, the display object is moved to a position where it does not obstruct the visibility of the object. FIG. 11 illustrates an example of the avoidance display.

In the example of FIG. 11, when a display object 320 is placed on the local coordinate system while a user is viewing an acquaintance 322 as an object in the outside world, the display object 320 overlaps the acquaintance 322 as illustrated in the upper part of FIG. 11. In such a case, the processor 101 moves the display object 320 away to prevent the display object 320 from overlapping the acquaintance 322, and displays it. Moving the display object 320 like above causes the area required for displaying the display object 320 to extend beyond the display area 111a, and thus the processor 101 places the display object 320 on the non-local coordinate system as an enlarged area display object 321.

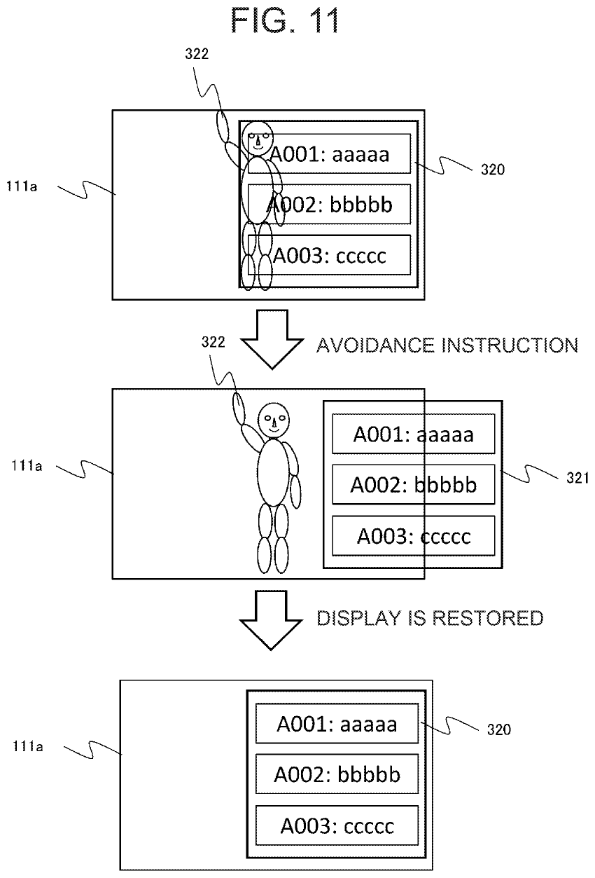

FIG. 12 illustrates a flowchart of a flow of the processing of FIG. 11.

When the processor 101 places the display object 320 on the local coordinate system to display it (step S101), the display object 320 overlaps the acquaintance 322 (upper part of FIG. 11). The processor 101 waits for a user instruction in this state (step S102). When the user enters an “avoidance instruction” as the display change instruction, the “avoidance instruction” becomes the “enlarged area display instruction” (step S103: YES).

The processor 101 calculates the position on the non-local coordinate system, where the acquaintance 322 (avoidance target) can be viewed in the display area 111a based on the image from the out-camera 109 (step S130).

Upon determining that the display object 320 has to be displayed beyond the display area (step S131: YES), the processor 101 moves the display object 320 away from the avoidance target and places it on a non-local coordinate system to display the enlarged area display object 321 (step S132).

While the processor 101 is waiting for a user instruction (step S106) and when the user enters an “avoidance cancellation instruction”, the “avoidance cancellation instruction” becomes the “enlarged area display termination instruction” (step S107: YES). The processor 101 changes the placement of the display object 320 from the non-local coordinate system to the local coordinate system, and terminates the enlarged area display (step S108). This restores the display illustrated in the lower part of FIG. 11.

An object to be avoided by a display object may not only be an object in the outside world. The avoidance display may be carried out as well for the case where the display objects obstruct the visibilities thereof within the display area 111a from each other.

The “avoidance instruction” and “avoidance cancellation instruction” have been described so far with an example of using a gesture operation as an input operation made by a user to cause the processor 101 to recognize it. In addition, the “avoidance instruction” and “avoidance cancellation instruction” may be carried out based on the result obtained by determining whether a display object overlaps an object in the outside world that can be viewed through the display area 111a or another display object, whose positions are calculated, respectively, by the processor 101 of the HMD 1 using an image from the out-camera 109 as acquired.

On the other hand, upon determining that the display object 320 does not have to be displayed beyond the display area (step S131: NO), the processor 101 displays it with being placed as it is on the local coordinate system (step S109).

The processor 101 waits for a user instruction with the display object being placed on the local coordinate system (X_{L}, Y_{L}, Z_{L}) (step S110).

Upon accepting an input of a display termination instruction for the display object 300 (step S111: YES), the processor 101 terminates the display (step S112). In absence of the display termination instruction (step S111: NO), the processor 101 waits for the instruction from the user (step S110).

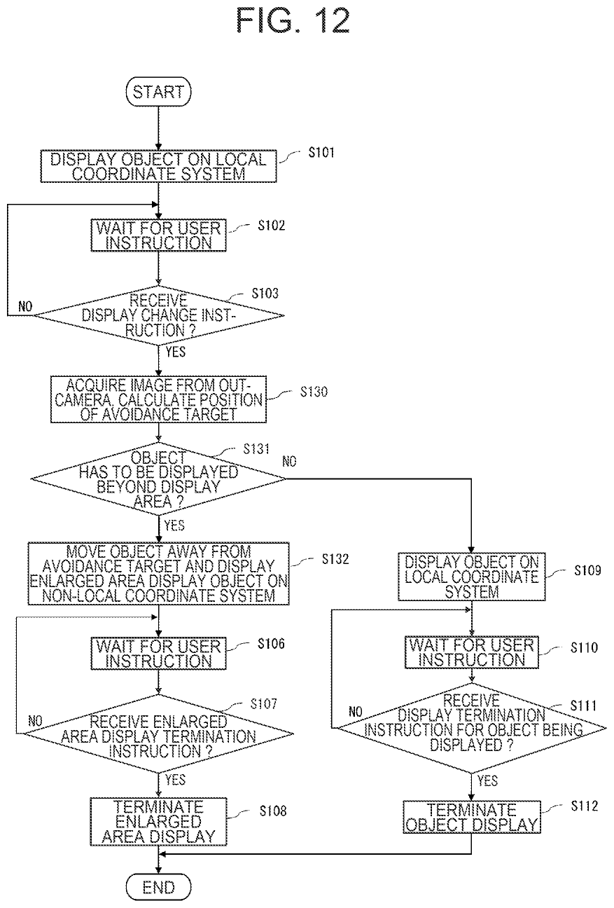

FIG. 13 illustrates a further example of the avoidance display. In the example of FIG. 13, an enlarged area display object 323 is displayed with preventively avoiding an area (restricted area 400) in which obstruction of the visibility is likely to occur, such as an area in the front direction of the body of a user. The restricted area 400 is the area defined on a non-local coordinate system.

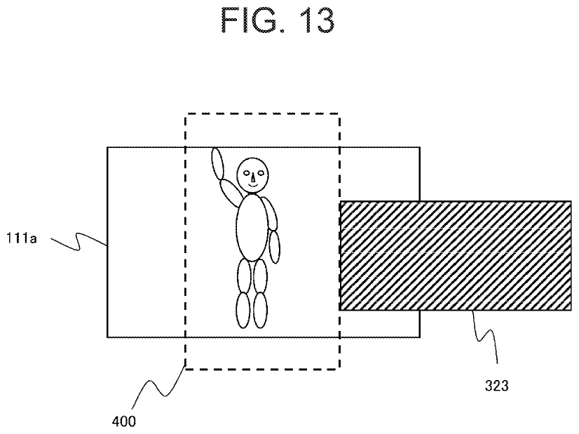

FIG. 14 illustrates a flowchart of a flow of the processing of FIG. 13.

When the user enters the “avoidance instruction” as the display change instruction, the “avoidance instruction” becomes the “enlarged area display instruction” (step S103: YES).

Upon determining that the enlarged area display object 323 overlaps the restricted area 400 (step S140: YES), the processor 101 moves the enlarged area display object 323 away from the restricted area 400 and displays it (step S141). Thereafter, the processor 101 waits for a user instruction (step S106).

Upon determining that the enlarged area display object 323 does not overlap the restricted area 400 (step S140: NO), the processor 101 places the enlarged area display object 323 on a non-local coordinate system to displays it (step S142). Thereafter, the processor 101 waits for a user instruction (step S106).

In the case of the simple enlargement, the position of the center of enlargement of an enlarged area display object may be adjusted to prevent the enlarged area display object from extending in the front direction. For example, it may be set such that, using a predetermined inner area from the periphery of the displayed area 111a as a reference, the enlarged area display object extends from the predetermined inner area further away from the restricted area 400. Furthermore, before the avoidance display is carried out, an area for display which is provided so as to include less obstruction in advance may be presented to a user so that whether the avoidance display is necessary can be selected by him or her.

### (Change of Transparency for Display)

If switching to the enlarged area display causes obstruction of the visibility of other objects including a real object in the outside world, “change of transparency for display” for increasing the rate of transparency of a portion of a display object which obstructs the visibility may be carried out.

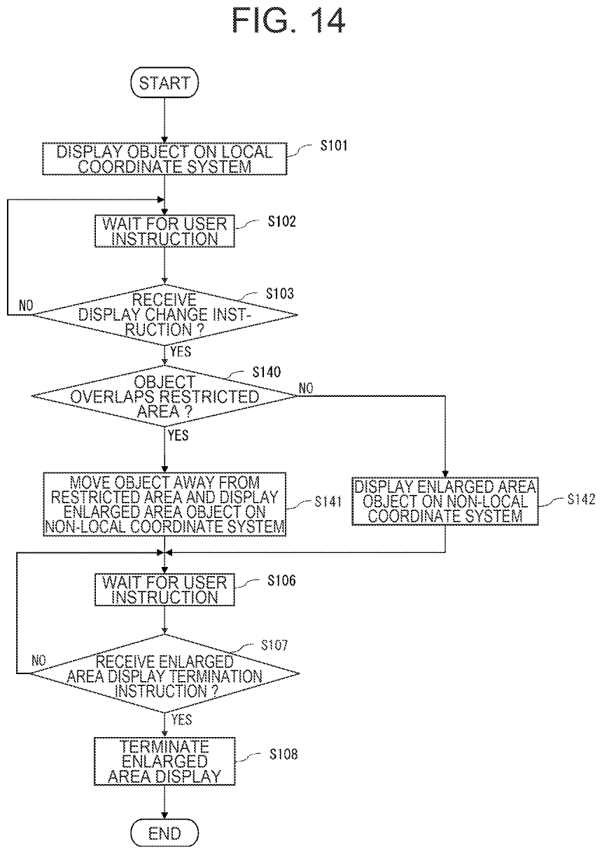

FIG. 15 illustrates an example of changing the transparency for display. In the example of FIG. 15, an area (restricted area 400) in which obstruction of the visibility is likely to occur, such as an area in the front direction of the body of a user is set preventively, and the rate of transparency of an area of the enlarged area display object 323 which overlaps the restricted area 400 is increased.

In the example of FIG. 15, instead of the processing in which the processor 101 moves an enlarged area display object away from the restricted area 400 and displays it on the non-local coordinate system in step S141 of FIG. 14, the enlarged area display object 323 is displayed with the rate of transparency of a portion thereof overlapping the restricted area 400 being increased while the position thereof on the non-local coordinate system being kept.

### (Processing for Original Display Object)

There are several approaches for processing the original display object after the enlarged area display is applied, which corresponds to the display object before the enlarged area display is applied, mainly for example, hiding it or keeping displaying it. In the latter case, an appropriate approach to display it can be selected from displaying it as it is, displacing the display position, iconizing it and reducing the size, or displaying it with a light color.

According to the first embodiment, in the case where enlarging a display object on a local coordinate system causes the display object as enlarged not to be fully displayed on the local coordinate system, in other words, cannot be fully displayed within the display area 111 of the display 103, a coordinate system on which the display object as enlarged is to be placed is switched to a non-local coordinate system and the display object is placed as an enlarged area display object. This enables a user to view the enlarged area display object only by changing the direction and position of the HMD 1, and thus realizes the improvement in the usability of the HMD 1.

Furthermore, according to the first embodiment, in the case where the whole of an enlarged object on a local coordinate system becomes invisible due to the size of a display area necessary for displaying the enlarged object, restrictions on the display position caused by avoidance of obstructions, and the like, the enlarged area display is carried out by placing an enlarged object on a non-local coordinate system. On the other hand, in the case where the enlarged object can be displayed within the local coordinate system, it is kept being displayed on the local coordinate system. Thus, using the local coordinate system for displaying an enlarged object as much as possible realizes the improvement in the usability.

### <Non-Local Coordinate System>

A non-local coordinate system other than the world coordinate system may be employed as long as it is fixed to the real space instead of being fixed to the displaying area 111 of the HMD 1. The type of a non-local coordinate system to be used may be switched in accordance with a user instruction. In the following, a modified example of the non-local coordinate systems will be described.

### (Chest Coordinate System)

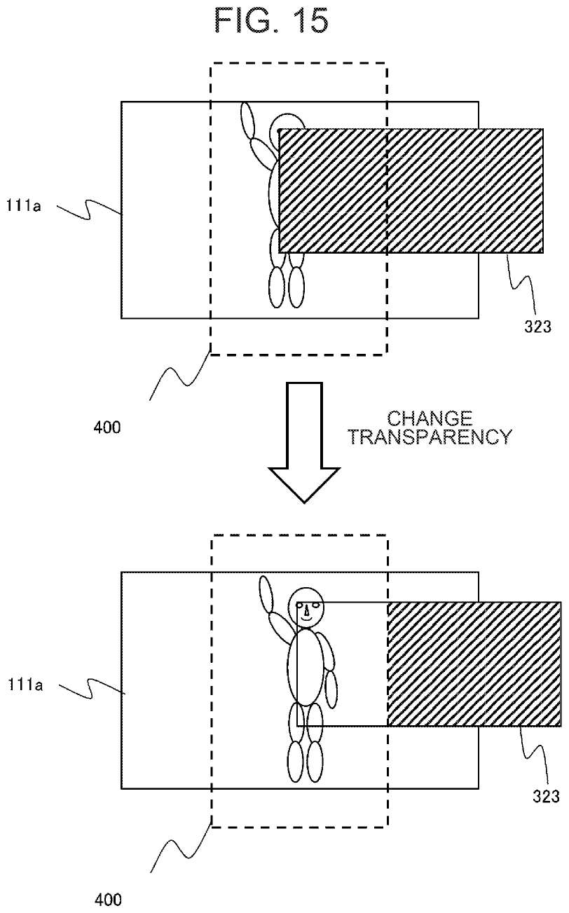

FIG. 16 is a diagram for explaining a chest coordinate system (X_{B}, Y_{B}, Z_{B}).

The chest coordinate system is the coordinate system that is fixed to the chest of a user wearing the HMD 1. Using the chest coordinate system allows a display object to be placed around the front direction of the chest, and thus the placement area of the display object can be suitably widened within a range in which the user is not forced to turn his or her head even if the orientation of the body changes.

The chest coordinate system may be fixed to a remote controller of the HMD 1 hung from the neck of a user. Alternatively, the distance to the chest is obtained based on an image of the trunk of the user captured by the HMD 1, from which his or her chest is recognized, and then the chest coordinate system may be fixed to the chest based on the distance as obtained.

### (Inertial Coordinate System)

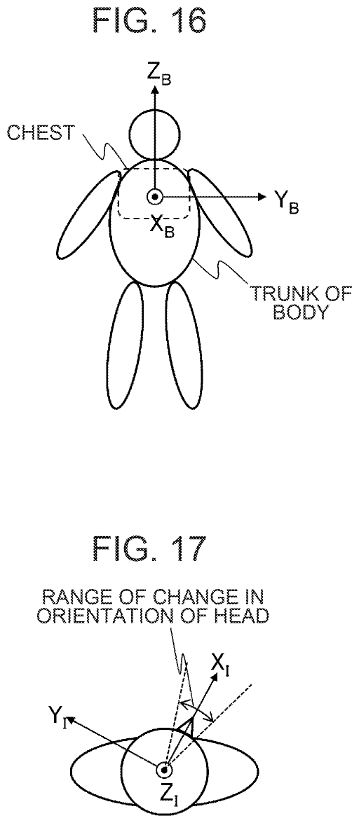

FIG. 17 is a diagram for explaining an inertial coordinate system (X_{I}, Y_{I}, Z_{I}).

The inertial coordinate system is the coordinate system that is fixed and set to the average position and orientation of the head. The inertial coordinate system is similar to the chest coordinate system, however, it differs from the chest coordinate system in that, while the chest coordinate system does not move once being fixed to the chest, in the inertial coordinate system, the direction of the coordinate system is set to follow the average direction of the face, that is, the head, when the face of the user is directed away from the front of the trunk of the body, for example, depending on the operations being performed. Placing a display object on the inertial coordinate system causes the placement area of the display object to be necessarily positioned near the front direction of the face. This enables the improvement in the usability.

### (Direction-Fixed Nonlocal Coordinate System)

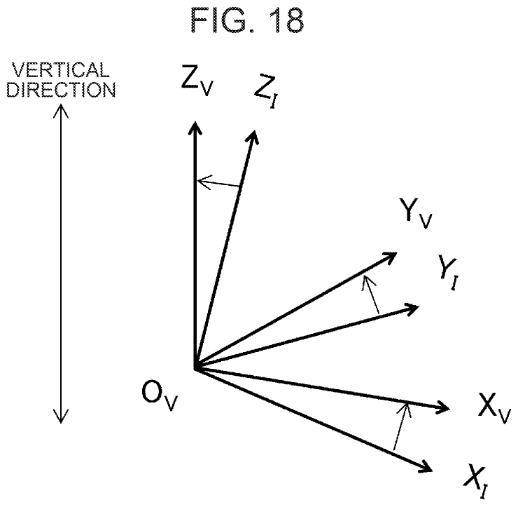

FIG. 18 is a diagram for explaining a direction-fixed nonlocal coordinate system (X_{V}, Y_{V}, Z_{V}).

The direction-fixed nonlocal coordinate system is the coordinate system which is a non-local coordinate system but different from the world coordinate system, and the vertical direction is made correspond to the vertical direction of the real world. For example, the direction-fixed nonlocal coordinate system rotates with the Z-axis direction always corresponding to the vertical direction (FIG. 18). The coordinate origin as the rotation center is set near a user. The vertical direction of a display object being displayed is maintained, which allows, a user, particularly for example, a user of the HMD 1 to view the display object while feeling naturally.

### (Plane-Fixed Nonlocal Coordinate System)

Each of FIG. 19 and FIG. 20 is a diagram for explaining a plane-fixed nonlocal coordinate system (X_{P}, Y_{P}).

The plane-fixed nonlocal coordinate system (XP, YP) is the coordinate system used for a mobile information terminal that is not worn on the body of a user, for example, the smartphone 5 or a tablet. In such a mobile information terminal, a distance between the mobile information terminal and the position of a viewpoint (eyeball position) of the user varies. If a display object is placed on the non-local coordinate system as described above, change in the distance between the smartphone 5 and the position of the viewpoint of the user would cause the change in the size of the display object on a screen. For this case, a non-local coordinate system configured with a two-dimensional coordinate system in which the screen of the flat display mounted on the smartphone 5 or the tablet is extended is used.

Specifically, the position of the smartphone 5 within a three-dimensional non-local coordinate system as appropriately set is changed by an integrated amount of the movement for the components that are parallel to the screen of the smartphone 5. At this time, the axial direction of the plane-fixed nonlocal coordinate system is made kept parallel to the axial direction of the local coordinate system of the smartphone 5 (FIG. 19). As a result, a coordinate system that is an extension area of the screen of the smartphone 5 can be configured in a wide area in front of the user in a natural way for the user.

Even if the vertical direction and horizontal direction of the smartphone 5 interchange from each other with respect to the housing of the smartphone 5 in the real space, the X-axis and Y-axis of the plane-fixed nonlocal coordinate system are made parallel to the X-axis and Y-axis of the local coordinate system of the smartphone 5, respectively (see FIG. 20).

In a mobile information terminal such as the HMD 1, smartphone 5, or a tablet, in addition to a local coordinate system, any non-local coordinate system may be selected from among a plurality of non-local coordinate systems and used.

Furthermore, it may be configured to let a user to know a coordinate system being used for display by providing a mark or the like on a display screen of the mobile information terminal.

### Second Embodiment

The second embodiment is the embodiment for providing an enlarged area display instruction and specification of a coordinate system used for display, simultaneously.

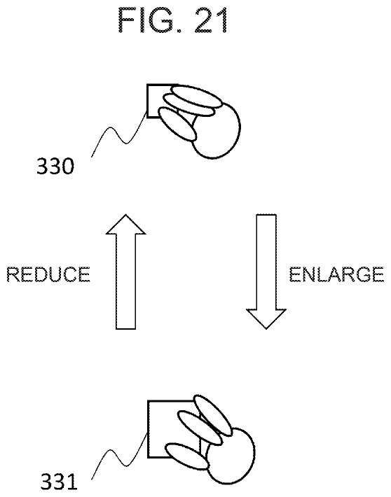

FIG. 21 is a diagram for explaining a user interface according to the second embodiment.

In a gesture action of spreading fingers to provide an enlargement and reduction instruction, the type of a non-local coordinate system on which an enlarged area display object 331 relating to the display object 330 is to be placed can be specified by changing the number of fingers used. For example, three fingers may be used for specifying the world coordinate system, five fingers may be used for specifying the chest coordinate system, and the like. Furthermore, for switching to a local coordinate system, a pinch-in operation using two fingers may be performed. This enables a placement coordinate system to be controlled by a simple instruction operation.

### Third Embodiment

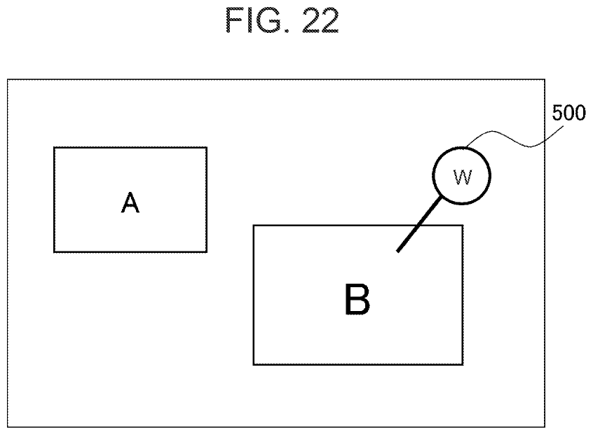

FIG. 22 is a diagram for explaining a user interface according to the third embodiment.

A display object representing an image of a fixed pin object 500 is prepared and associated with a non-local coordinate system. An operation of sticking the fixed pin object 500 to a display object serves as an operation for specifying the display object to be converted into the enlarged area display object and an operation for specifying the type of a non-local coordinate system on which the enlarged area display object is to be placed. A display object to which the fixed pin object 500 is not stuck (not pined) keeps to be placed on the local coordinate system. Removing the pin causes switching to the local coordinate system. The operation of sticking the pin of the non-local coordinate system may be configured to only cause the coordinate system to be switched, but it does not have to serve as an enlarged area display instruction. This enables the coordinate system to be switched by an intuitive instruction operation.

Furthermore, in the simple enlargement instruction, the position where the pin is stuck is fixed and then the object may be enlarged.

According to the present embodiment, for enlarging a display object displayed on a screen of a mobile information terminal such as the HMD 1, the smartphone 5, or a tablet, or displaying a display object requiring a display area larger than a display object relating thereto, switching a coordinate system on which the display object is to be placed from a local coordinate system to a non-local coordinate system as needed realizes the improvement in the usability of the mobile information terminal even with a small display. This results in the efficient utilization of resources. Furthermore, in terms of the reduction in the power consumption due to the reduction in the size of the display, it can be expected that the present embodiment contributes to the achievement of the goal 7 of SDGs.

The present invention is not limited to the embodiments described above, and includes various modifications. For example, the embodiments described above have been explained in detail for the purpose of clarifying the present invention, and the present invention is not limited to those having all the features as described. In addition, a part of the configuration of the present embodiments can be replaced with that of other embodiments, and the features of other embodiments and modifications can be added to the configuration of the present embodiments. Furthermore, it is possible to add, delete, or replace other configurations with respect to a part of the configuration of the present embodiments.

Some or all the configurations described above may be implemented by hardware, or by execution of programs by the processor. Furthermore, the control lines and information lines which are considered to be necessary for the purpose of explanation are indicated herein, but not all the control lines and information lines of actual products are necessarily indicated. It may be considered that almost all the configurations are actually connected to each other.

### REFERENCE SIGNS LIST

1: HMD
5: smartphone
10: housing
12: out-camera
13: range sensor
14: group of sensors
18: audio input unit
19: audio output unit
20: operation unit
31: control program
32: application program
33: setting information
34: display information
35: terminal position and orientation information
100: controller
101: processor
101A: communication control section
101B: display control section
101C: data processing section
101D: data acquisition section
102: memory
103: display
104: wireless communication unit
107: operation input unit
108: battery
111, 111a, 111b, 111c: display area
112, 112a: partial area
113: enlarged object
141: acceleration sensor
143: geomagnetic sensor
144: GPS receiver
300, 302, 303, 320, 330: display object
301, 304, 305: enlarged object
310: menu object
311: sub-menu
312: title object
313: remaining area
321. 323, 331: enlarged area display object
322: acquaintance
400: restricted area
500: fixed pin object

1. A mobile information terminal for displaying a display object, comprising:
a display; and
a processor configured to carry out display control of the display,
the processor being configured to:
calculate coordinates on which the display object is to be displayed, using, as a coordinate system for displaying the display object, a local coordinate system that is fixed to the mobile information terminal and a non-local coordinate system that is not fixed to the mobile information terminal; and
upon displaying an enlarged area display object, which is an object relating to the display object that is being displayed on the local coordinate system and requires, for displaying thereof, an enlarged area extending beyond a display area within the display, place the enlarged area display object on the non-local coordinate system.

2. The mobile information terminal according to claim 1, wherein
the processor is configured to:
when the object relating to the display object can be fully displayed in the display area within the display, display the object relating to the display object in the display area with being placed as it is on the local coordinate system, and
only when the object relating to the display object is to extend beyond the display area, place the object relating to the display object on the non-local coordinate system as the enlarged area display object.

3. The mobile information terminal according to claim 1, wherein
the object relating to the display object is an enlarged object obtained by simply enlargement of the display object.

4. The mobile information terminal according to claim 1, wherein
the object relating to the display object is an enlarged object obtained by simple enlargement of a partial area of the display area within the display.

5. The mobile information terminal according to claim 1, wherein
the display object is a menu object in which a menu is displayed, and
the object relating to the display object is a sub-menu in which details about one of items of the menu object are indicated.

6. The mobile information terminal according to claim 5, wherein
upon displaying the sub-menu, the processor places a title object indicating a content of the sub-menu on the local coordinate system to display the title object in the display area within the display.

7. The mobile information terminal according to claim 5, wherein
the processor is configured to:
when a display range of the sub-menu in the display area within the display is equal to or smaller than a remaining area generated by cutting out a portion of the sub-menu, place the remaining area on the local coordinate system to display the remaining area in the display area within the display, and
when the display range of the sub-menu included in the display area within the display is larger than the remaining area, place the sub-menu on the non-local coordinate system without generating the remaining area.

8. The mobile information terminal according to claim 1, further comprising a camera for capturing an image of an area where a user of the mobile information terminal can view, wherein
the display is a transparent display, and
the processor is configured to:
upon determining, based on the image by the camera, that the display object overlaps a real object in an outside world which has been captured in the image by the camera, move the display object away from an area of the display area of the display, through which the real object in the outside world can be viewed transparently, and place the display object on the non-local coordinate system as the enlarged area display object; and
when the real object in the outside world has not been captured in the image by the camera, place the enlarged area display object on local coordinate system again as the display object.

9. The mobile information terminal according to claim 1, further comprising a camera for capturing an image of an area where a user of the mobile information terminal can view, wherein
the display is a transparent display, and
the processor is configured to, in the display area within the display, provide a restricted area in which the display object is prevented from being displayed, and when the display object is to extend beyond the display area if moving the display object away from the restricted area, place the display object on the non-local coordinate system as the enlarged area display object.

10. The mobile information terminal according to claim 1, further comprising a camera for capturing an image of an area where a user of the mobile information terminal can view, wherein
the display is a transparent display, and
the processor is configured to, in the display area within the display, provide a restricted area in which the display object is prevented from being displayed, and increase a rate of transparency of a portion of the enlarged area display object which overlaps the restricted area to place the enlarged area display object on the non-local coordinate system.

11. The mobile information terminal according to claim 1, wherein
the non-local coordinate system is a chest coordinate system configured with a coordinate system that is fixed to a chest of a user of the mobile information terminal.

12. The mobile information terminal according to claim 1, wherein
the non-local coordinate system is an inertial coordinate system that is fixed and set to an average position and orientation of a head of a user of the mobile information terminal.

13. The mobile information terminal according to claim 1, wherein
the non-local coordinate system is a direction-fixed nonlocal coordinate system that is different from a world coordinate system, in which a vertical direction of the non-local coordinate system is made correspond to a vertical direction of the real world.

14. The mobile information terminal according to claim 1, wherein
the mobile information terminal is a smartphone or a tablet terminal, and
the non-local coordinate system is a plane-fixed nonlocal coordinate system configured with a two-dimensional coordinate system in which a screen of a flat display mounted on the smartphone or the tablet terminal is extended.

15. The mobile information terminal according to claim 1, further comprising a camera, wherein
the processor is configured to:
recognize a gesture action using a hand of a user based on an image by the camera to accept an input operation; and
using the number of fingers of the hand of the user and a motion of the hand of the user, accept an operation to specify a type of the non-local coordinate system and the input operation for converting the display object into the enlarged area display object or reconverting the enlarged area display object into the display object.

16. The mobile information terminal according to claim 1, wherein
the processor is configured to:
by means of an operation of sticking a fixed pin object to the display object, accept a specification of the display object displayed in the display area within the display and a specification of a type of the non-local coordinate system on which the display object is to be placed; and
convert the display object to which the fixed pin object is stuck into the enlarged area display object and place the enlarged area display object on the non-local coordinate system of the type which has been specified.

17. The mobile information terminal according to claim 1, wherein the processor accepts a user instruction for forcibly placing the object relating to the display object on the non-local coordinate system.

18. An object display method for displaying a display object on a display mounted on a mobile information terminal, the method being executed by a processor mounted on the mobile information terminal, comprising the steps of:
calculating coordinates on which the display object is to be displayed, using, as a coordinate system for displaying the display object, a local coordinate system that is fixed to the mobile information terminal and a non-local coordinate system that is not fixed to the mobile information terminal; and
upon displaying an enlarged area display object, which is an object relating to the display object that is being displayed on the local coordinate system and requires, for displaying thereof, an enlarged area extending beyond a display area within the display, placing the enlarged area display object on the non-local coordinate system.
